(19) United States
(12) Patent Application Publication
(10) Pub. No.: US 2006/0126507 A1
(43) Pub. Date: Jun. 15, 2006

(54) Wireless base station device and rate control method thereof

(75) Inventor: Kanada Nakayasu, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Corporation, Tokyo (JP)

(21) Appl. No.: 11/300,380

(22) Filed: Dec. 15, 2005

(30) Foreign Application Priority Data
Dec. 15, 2004 (JP) 2004-363082

(51) Int. Cl. H04L 12/26; H04Q 7/00; H04J 3/22; H04Q 7/24; H04L 1/00; H04J 3/16

(52) U.S. Cl. 370/229; 370/468; 370/328; 370/338

(57) ABSTRACT

A wireless base station device, connected to a higher-level station device via a wired line, comprises baseband processors 11, one for each virtual link 21 to which user data flows belong. In the baseband processor 11, a congestion monitor 51 monitors the reception bandwidth usage rate of a virtual link allocated to each cell for detecting congestion and, upon detecting congestion, sends a notification to a flow controller 57. A user traffic distributor 52 distributes a received user traffic into the traffic flow of each user and, at the same time, extracts, for each user data flow, the buffer holding amount in the higher-level station device where user data flows are multiplexed and sends a notification to the flow controller 57. The flow controller 57 manages the data flow of each user and, in response to a congestion notification from the congestion monitor 51, requests the higher-level station device to reduce the rate of a user data flow in descending order of rates beginning with a data flow with a highest rate.

### FIELD OF THE INVENTION

The present invention relates to a wireless base station device and its rate control method, and more particularly to a wireless base station device that processes high peak-throughput, high-burstiness data and to a data flow rate control method used in the wireless base station device.

### BACKGROUND OF THE INVENTION

Recently, the size of contents available for a mobile phone becomes larger and larger. In future, there will be a rapidly increasing need for the high-speed transmission of large contents such as those used in moving-picture delivery. To meet the need for such a high-speed data communication, there is a best effort packet data communication method called High Speed Downlink Packet Access (HSDPA). This method employs the adaptive modulation/coding scheme and the packet combination hybrid ARQ (Automatic Repeat Request) to increase the speed, and improve the quality, of data communication.

Such a best effort packet data communication method is required to process high peak-throughput, high-burstiness data in many cases. In a wireless communication system where the flow of user data is multiplexed on a wired line between a wireless base station device and a higher-level wireless base station device, the peak throughput and burstiness of data are increased. To solve this problem, a sufficient bandwidth is allocated to the wired line to avoid congestion.

On the other hand, a method is disclosed in Patent Document 1 as a related technology. This method dynamically adjusts the bandwidth/power level, allocated to a given data service in a wireless communication system, to the actual data rate required by a source. According to this method, when the amount of data in the sending or receiving buffer exceeds a predetermined threshold, an auxiliary data channel is used to set a high data rate to allow a base station to manage the data buffer within a specified threshold.

Patent Document 2 discloses a packet transfer rate control method for equally allocating the bandwidth among the Internet users. This method estimates the number of user data flows of each class from the traffic measurement values and checks if the link is the bottleneck of each user flow. Based on the checking result, each node dynamically changes the weight of the class buffer to control the packet transfer rate of the users.

[Patent Document 1] Japanese Patent Kokai Publication No. JP-P2000-316035A

[Patent Document 2] Japanese Patent Kokai Publication No. JP-P2002-57707A

### SUMMARY OF THE DISCLOSURE

One of data processed by the HSDPA-based bearer service is non-realtime data such as that used in the best effort service. In the HSDPA-based best effort service, it is expected that the peak throughput and the burstiness become extremely high. In this case, the utilization of a wired line between the wireless base station controller and the wireless base station device is decreased and, therefore, a wider bandwidth wired line is necessary.

That is, in an HSDPA wireless base station device where the same spread encoder is time-shared by multiple users to increase the utilization of a wireless resource for higher throughput of user data, one of the problems is that the bandwidth cost of the wired line between a wireless base station and a wireless base station controller is increased to meet the increased throughput of the wireless line.

It is an object of the present invention, when high peak-throughput, high burstiness data is processed by a data communication method such as HSDPA, to increase the utilization of a wired line and to minimize the wired line cost that is increased by the introduction of HSDPA.

To solve the problems described above, the present invention provides the following. In one aspect, the present invention provides a rate control method, for use in a wireless base station device when congestion occurs in data flows from a higher-level station device, for setting rates of the data flows to a rate lower than a predetermined bandwidth. In this method, each of the data flows is managed and, based on a holding amount of data that is held in a buffer in the higher-level station device and that corresponds to the each data flow, a notification is sent to the higher-level station device to request that the rates be reduced in descending order of rates beginning with a data flow with a highest rate.

In another aspect, the present invention provides a rate control method, for use in a wireless base station device when congestion occurs in a virtual link to which data flows belong, for setting rates of the data flows to a rate lower than a predetermined bandwidth. This method comprises the steps of (a) calculating a data flow rate R_{flow}_{_{—}}_{reduced}(n) using R_{flow}_{_{—}}_{reduced}(n)=N_{flow}(n)/T_{MAX}_{_{—}}_{flow} where N_{flow}(n) is a holding amount of data that is held in a buffer in a higher-level station device and that corresponds to an nth (n is a natural number) data flow and T_{MAX}_{_{—}}_{flow} is a maximum holding time allowed in the buffer; (b) calculating a bandwidth reduction rate R_{VL}_{_{—}}_{reduced}(n) (R_{flow}(n)-R_{flow}_{_{—}}_{reduced}(n))/Rᵥₗᵢₙₖ (where Rᵥₗᵢₙₖ is a maximum bandwidth of the virtual link) of the nth data flow; and (c) if the bandwidth reduction rate R_{VL}_{_{—}}_{reduced}(n) is equal to or higher than a predetermined bandwidth reduction rate, sending flow control information to the higher-level station device to request that the rate of the nth data flow be set to R_{flow}_{_{—}}_{reduced}(n).

In still another aspect, the present invention provides a wireless base station device connected to a higher-level station device and comprising baseband processors, one for each virtual link to which one or more data flows belong. Each of the baseband processors comprises a congestion monitor that monitors a reception bandwidth usage rate of a virtual link, allocated to a cell, to detect congestion and, if congestion is detected, notifies congestion information to a flow controller; a traffic distributor that distributes user traffic, received from said higher-level station device, to a traffic flow of each user and, at the same time, extracts a holding amount of a buffer in said higher-level station device for each data flow and notifies the extracted holding amount to the flow controller; and the flow controller that manages a data flow of each user and, if the congestion information is notified by said congestion monitor, requests said higher-level station device to reduce rates of data flows in descending order of rates beginning with a data flow with a highest rate.

The meritorious effects of the present invention are summarized as follows.

According to the present invention, a wireless base station device controls the data flow amount of each user considering the data holding amount in a higher-level station device (wireless base station controller) when congestion is detected. This allows the bandwidth of a wired line to be efficiently controlled between the wireless base station and the wireless base station controller while minimizing the occurrence of a buffer overflow in the wireless base station controller when congestion occurs. Therefore, the bandwidth cost of the wired line can be reduced.

### BRIEF DESCRIPTION OF THE DRAWINGS

FIG. 1 is a block diagram showing the configuration of the connection between a wireless base station device in a first embodiment of the present invention and a wireless base station controller.

FIG. 2 is a block diagram showing the configuration of a baseband processor.

FIG. 3 is a flowchart showing the operation of the baseband processor in the first embodiment of the present invention.

FIG. 4 is a flowchart showing the operation of the baseband processor in a second embodiment of the present invention.

### PREFERRED EMBODIMENTS OF THE INVENTION

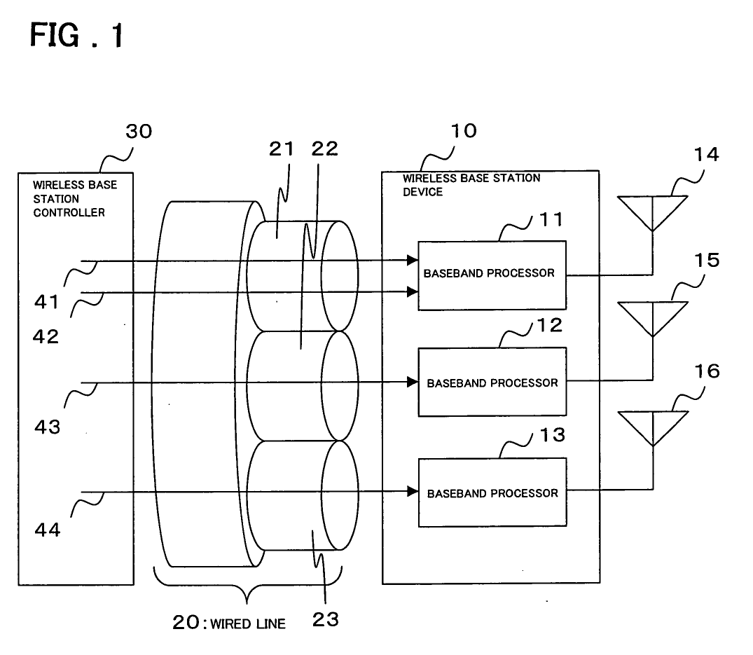

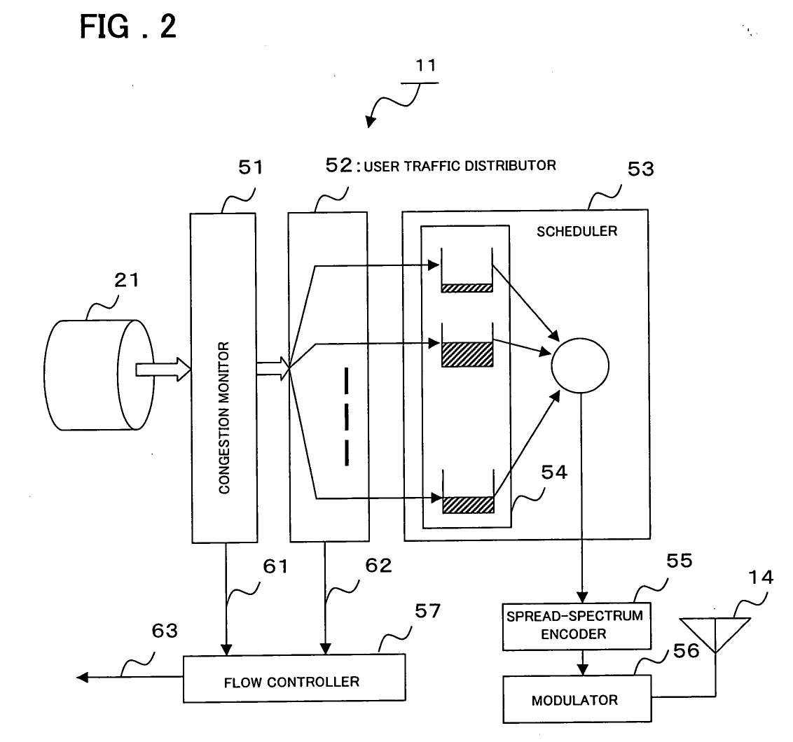

A wireless base station device (10 in FIG. 1) in a preferred embodiment of the present invention, connected to a wireless base station controller (30 in FIG. 1), comprises baseband processors (11, 12, and 13 in FIG. 1) for virtual links (21, 22, and 23 in FIG. 1) to which user data flows (41, 42, 43, and 44 in FIG. 1) belong, one baseband processor for each virtual link. A baseband processor (11 in FIG. 2) comprises a congestion monitor (51 in FIG. 2), a traffic distributor (52 in FIG. 2), and a flow controller (57 in FIG. 2). The congestion monitor monitors the reception bandwidth usage rate of a virtual link allocated to each cell to detect congestion and, when it finds congestion, notifies congestion information to the flow controller. The traffic distributor distributes the user traffic, which is received from the wireless base station controller, into the traffic flow of each user and, at the same time, extracts, for each user data flow, the buffer holding amount in the wireless base station controller where user data flows are multiplexed and notifies the extracted holding amount to the flow controller. The flow controller manages the data flow of each user and, in response to a congestion notification from the congestion monitor, requests the wireless base station controller to reduce the rate of a user data flow in descending order of rates beginning with a data flow with a highest rate.

The wireless base station device with the configuration described above monitors congestion and, when congestion is detected, controls the data flow mount of each user considering the data holding amount in the wireless base station controller. This control method efficiently controls a data flow that would otherwise increase the load of the bandwidth and, therefore, efficiently processes a high-burstiness data flow. In addition, because a flow is controlled according to the data amount, the bandwidth of a wired line can be controlled efficiently while minimizing the occurrence of a buffer overflow in the wireless base station controller when congestion occurs. Therefore, the bandwidth can be controller efficiently and the bandwidth cost of a wired line can be reduced by the instruction of HSDPA. The following describes embodiments more in detail.

### First Embodiment

FIG. 1 is a block diagram showing the configuration of the connection between a wireless base station device in a first embodiment of the present invention and a wireless base station controller. Referring to FIG. 1, a wireless base station device 10 comprises baseband processors 11, 12, and 13 each of which has an antenna 14, 15, or 16, respectively. The wireless base station device 10 is connected to a wireless base station controller 30 via a wired line 20. In the description below, the wireless base station device 10 covers three cells (cells #1, #2, and #3) and has baseband processors 11, 12, and 13, one for each cell. Note that the number of cells is not limited to three.

Each of the baseband processors 11, 12, and 13 once stores a user traffic from the wireless base station controller 30 into the buffer, performs spread spectrum modulation according to the data traffic priority among the users in the same cell, and sends the modulated data to wireless lines via the antenna 14, 15, or 16.

The wired line 20 comprises virtual links 21, 22, and 23 each of which corresponds to one of the cells. The bandwidth of each virtual link is limited to a predetermined value.

The wireless base station controller 30 sends a user data flow, received from a higher-level device such as a mobile communication exchange not shown, to the wireless base station device 10 via the virtual link corresponding to the cell where the user belongs. In FIG. 1, it is assumed that a user data flow 41 and a user data flow 42 correspond to cell #1, a user data flow 43 corresponds to cell #2, and a user data flow 44 corresponds to cell #3. It is also assumed that each user data flow has a data holding amount indication that indicates the amount of data held in the buffer in the wireless base station controller 30.

FIG. 2 is a block diagram showing the configuration of the baseband processor. Because the baseband processors 11, 12, and 13 have the same configuration, the following describes only the baseband processor 11. The baseband processor 11 comprises a congestion monitor 51, a user traffic distributor 52, a scheduler 53, a spread-spectrum encoder 55, a modulator 56, and a flow controller 57. The scheduler 53 also has a buffer 54.

The congestion monitor 51 has the function to constantly monitor the reception bandwidth usage rate of the virtual link 21 allocated to each cell. In addition, the congestion monitor 51 has a function, which is used when it detects congestion, to notify the congestion information to the flow controller 57 using a congestion state notification interface 61.

The user traffic distributor 52 distributes a user traffic, received from the wired line 20, into multiple traffic flows, one for each user, and accumulates the traffic flow in the buffer 54 in the scheduler 53 provided for each user. The accumulated user traffic is selected by the scheduler 53 in a time-dividing manner and is spread-spectrum modulated by the spread-spectrum encoder 55 in order in which the user traffics are selected. After that, the user traffic is modulated by the modulator 56 into a wireless frequency for transmission from the antenna 14 as an electric wave.

The user traffic distributor 52 also has a function to extract, for each user data flow, the holding amount of the buffer in the wireless base station controller 30 where the user data flows are multiplexed and to notify the buffer holding amount to the flow controller 57 via a buffer holding information notification interface 62.

The flow controller 57 receives the congestion state notified by the congestion monitor 51 via the congestion state notification interface 61 and the buffer holding amount notified by the user traffic distributor 52 via the buffer holding information notification interface 62. Based on the congestion state and the buffer holding amount that have been received, the flow controller 57 sends flow control information 63 to the wireless base station controller 30. The flow control information 63 that is sent in this way controls the amount of user data flow sent by the wireless base station controller 30.

The following describes an actual example of the operation of the baseband processor according to the present invention. The congestion monitor 51 in FIG. 2 measures the usage rate of the reception bandwidth for each virtual link at an interval of a predetermined period. For example, when the wired line 20 is an ATM line, the congestion monitor 51 calculates the bandwidth usage rate (Bandwidth usage rate=Number of received ATM cells except idle cells/Maximum number of ATM cells at the maximum rate) for each unit time.

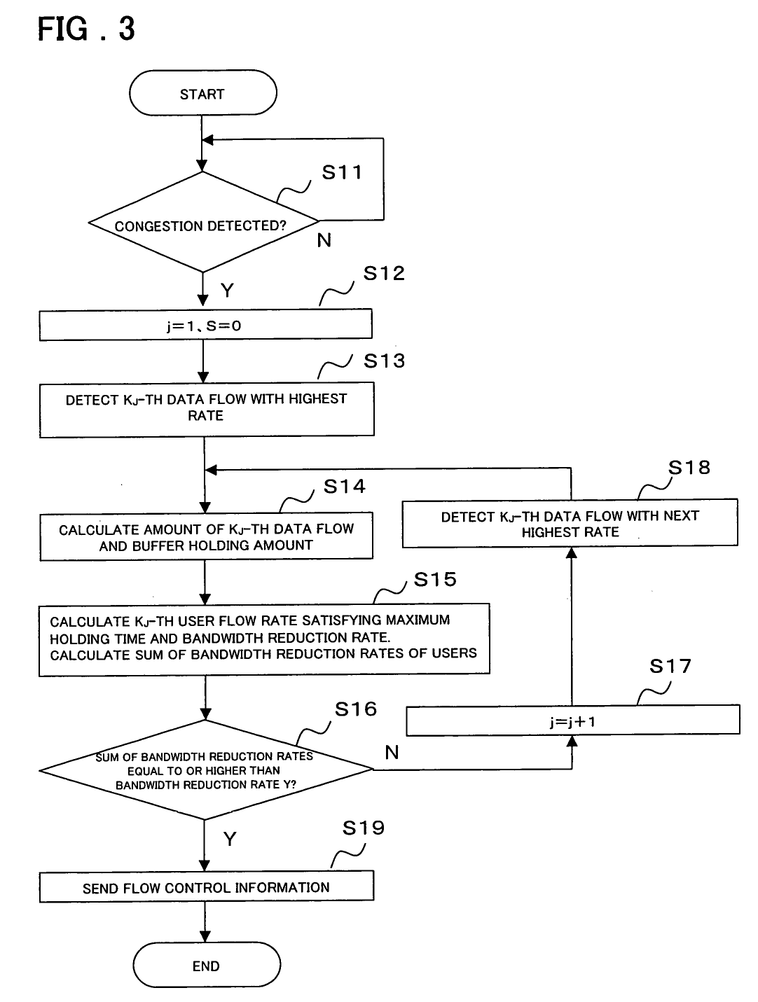

FIG. 3 is a flowchart showing the operation of the baseband processor in the first embodiment of the present invention. In the description below, the rate between the amount of bandwidth to be reduced at congestion detection time and the maximum bandwidth of the virtual link is expressed as the bandwidth reduction rate y. The maximum holding time allowed in the buffer in the wireless base station controller 30 is expressed as the maximum holding time T_{MAX}_{_{—}}_{flow}.

First, in step S11, the congestion monitor 51 checks if congestion is detected. That is, the congestion monitor 51 compares the bandwidth usage rate with the bandwidth usage rate threshold that is specified externally. If the bandwidth usage rate exceeds the threshold, the congestion monitor 51 notifies the congestion information, which indicates that congestion is detected, to the flow controller 57 via the congestion state notification interface 61.

In step S12, the user data flow identification subscript j is set to 1. The sum S of the bandwidth reduction rates calculated for each flow is set to 0.

In step S13, the flow controller 57, which has received a notification from the congestion monitor 51, detects the kⱼ-th user data flow that has the maximum user data rate when the congestion was detected.

In step S14, the flow controller 57 detects the user data flow rate R_{flow}(kⱼ) and the latest holding (retention) amount N_{flow}(kⱼ) of data of the kⱼ-th user data flow held in the buffer in the wireless base station controller 30 from the information received from the user traffic distributor 52 via the buffer holding information notification interface 62.

In step S15, the flow controller 57 calculates the user flow rate R_{flow}_{_{—}}_{reduced}(kⱼ), which satisfies the maximum holding (retention) time T_{MAX}_{_{—}}_{flow}, using expression (1).
R_{flow}_{_{—}}_{reduced}(kⱼ)=N_{flow}(kⱼ)/T_{MAX}_{_{—}}_{flow} Expressoin (1)

The flow controller 57 calculates the bandwidth reduction rate R_{VL}_{_{—}}_{reduced}(kⱼ) of the kⱼ-th user from R_{flow}(kⱼ) using expression (2).
R_{VL}_{_{—}}_{reduced}(kⱼ)=(R_{flow}(kⱼ)−R_{flow}_{_{—}}_{reduced}(kⱼ))/Rᵥₗᵢₙₖ Expression (2)
where, Rᵥₗᵢₙₖ is the maximum bandwidth of the virtual link.

In addition, the flow controller 57 calculates the sum S of the bandwidth reduction rates using expression (3).
S=S+R_{VL}_{_{—}}_{reduced}(kⱼ) Expression (3)

In step S16, if the sum S of the bandwidth reduction rates is lower than the bandwidth reduction rate y, control is passed to step S17. If the sum S of the bandwidth reduction rates is the bandwidth reduction rate y or higher, control is passed to step S19.

In step S17, user data flow identification subscript j is incremented by 1.

In step S18, the flow controller 57 detects the kⱼ-th user data flow rate that is the next highest user data rate immediately before detecting congestion. Control is passed back to step S14.

In step S19, the flow controller 57 sends the flow control information 63 to the wireless base station controller 30 to request that the kⱼ-th data flow be set to R_{flow}_{_{—}}_{reduced}(kⱼ) for each detected user data flow. That is, if n (n is a natural number) data flows are detected, the flow controller 57 sends information requesting that the kⱼ-th data flow be set to R_{flow}_{_{—}}_{reduced}(kⱼ) for j ranging from 1 to n. After that, the sequence of processing is terminated.

As described above, when congestion occurs, the flow controller 57 controls the data flow amount of each user considering the data holding amount in the wireless base station controller. Because the flow amount is controlled according to the data amount, the occurrence of a buffer overflow in the wireless base station controller when congestion occurs can be minimized.

### Second Embodiment

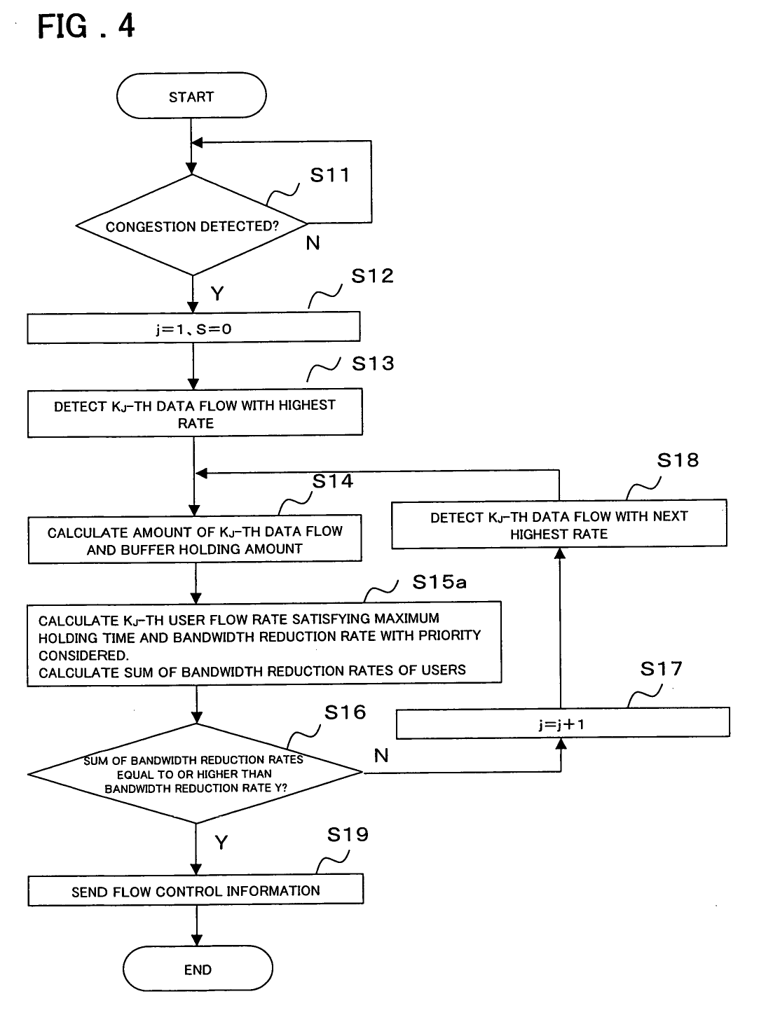

FIG. 4 is a flowchart showing the operation of baseband processor in a second embodiment of the present invention. In FIG. 4, in a step with the same reference numeral as that in FIG. 3, the same operation is performed and therefore the description of that step will be omitted. The processing in FIG. 4 differs from the processing in FIG. 3 in that the traffic amount at congestion occurrence time is controlled considering user's priority. For example, in step S15a, the maximum holding time T_{MAX}_{_{—}}_{flow}_{_{—}}_{Priority}(kⱼ), which is the maximum holding time with priority considered, is used instead of the maximum holding time T_{MAX}_{_{—}}_{flow}.

The maximum holding time T_{MAX}_{_{—}}_{flow}_{_{—}}_{Priority}(kⱼ) with priority considered is generated by correcting the maximum holding time T_{MAX}_{_{—}}_{flow} as shown in expression (4).
T_{MAX}_{_{—}}_{flow}_{_{—}}_{Priority}(kⱼ)=α(P)*T_{MAX}_{_{—}}_{flow} Expression (4)
α(P), which is a coefficient determined according to the priority of each user, is the coefficient for a user with priority P. At this time, the relation of the coefficients is α(1)<α(2)<α(3) . . . etc. and the relation of priority is 1>2>3, . . . etc.

Correcting the maximum holding time by the priority in this way makes the maximum holding time of a high-priority user apparently short, and the maximum holding time of a low-priority user apparently long. That is, when controlling the data rate of each user upon detecting congestion, the attenuation of the data rate can be decreased for a high-priority user, and can be increased for a low-priority user. This makes the bandwidth control more efficient.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A rate control method, for use in a wireless base station device when congestion occurs in data flows from a higher-level station device, for setting rates of the data flows to a rate lower than a predetermined bandwidth comprising:
managing each of the data flows and holding data in a buffer in a higher-level station device; and,
based on a holding amount of data that is held in said buffer and that corresponds to each data flow, sending a notification to said higher-level station device to request to reduce rates in descending order of rates beginning with a data flow with a highest rate.

2. The rate control method for use in a wireless base station device as defined by claim 1 wherein the rate of said each data flow is reduced so that the rate becomes equal to a rate determined by a ratio between the holding amount and a maximum holding time allowed in said buffer.

3. The rate control method for use in a wireless base station device as defined by claim 2 wherein priority is allocated to said each data flow to set the maximum holding time, which corresponds to a high-priority data flow, shorter.

4. The rate control method for use in a wireless base station device as defined by claim 1 wherein the congestion is congestion that occurs in a virtual link unit to which the data flows belong.

5. A rate control method, for use in a wireless base station device when congestion occurs in a virtual link unit to which data flows belong, for setting rates of the data flows to a rate lower than a predetermined bandwidth, said rate control method comprising the steps of:
(a) calculating a data flow rate R_{flow}_{_{—}}_{reduced}(n) using R_{flow}_{_{—}}_{reduced}(n)=N_{flow}(n)/T_{MAX}_{_{—}}_{flow} where N_{flow}(n) is a holding amount of data that is held in a buffer in a higher-level station device and that corresponds to an nth (n is a natural number) data flow and T_{MAX}_{_{—}}_{flow} is a maximum holding time allowed in the buffer;
(b) calculating a bandwidth reduction rate of the nth data flow R_{VL}_{_{—}}_{reduced}(n)=(R_{flow}(n)-R_{flow}_{_{—}}_{reduced}(n))/Rᵥₗᵢₙₖ of the nth data flow where Rᵥₗᵢₙₖ is a maximum bandwidth of the virtual link; and
(c) if the bandwidth reduction rate R_{VL}_{_{—}}_{reduced}(n) is equal to or higher than a predetermined bandwidth reduction rate, sending flow control information to the higher-level station device to request to set the rate of the nth data flow to R_{flow}_{_{—}}_{reduced}(n).

6. The rate control method for use in a wireless base station device as defined by claim 5 further comprising:
executing said step (a) and said step (b) for the data flows in descending order of rates beginning with a data flow with a highest rate;
calculating a sum of the bandwidth reduction rates R_{VL}_{_{—}}_{reduced}(n) corresponding to the data flows for which said steps are executed,
instead of said step (c), executing said step (a) and said step (b) repeatedly until the sum becomes equal to or higher than the predetermined bandwidth reduction rate; and,
if the sum becomes equal to or higher than the predetermined bandwidth reduction rate, sending flow control information to the higher-level station device to request that the rate of each data flow, for which said step (a) and said step (b) are executed, be set to R_{flow}_{_{—}}_{reduced}(n).

7. The rate control method for use in a wireless base station device as defined by claim 5 wherein
priority is allocated to the nth data flow and, instead of the maximum holding time T_{MAX}_{_{—}}_{flow} corresponding to the nth data flow, αₙ*T_{MAX}_{_{—}}_{flow} is used where an is a coefficient representing the priority.

8. The rate control method for use in a wireless base station device as defined by claim 6 wherein
priority is allocated to the nth data flow and, instead of the maximum holding time T_{MAX}_{_{—}}_{flow} corresponding to the nth data flow, αₙ*T_{MAX}_{_{—}}_{flow} is used where an is a coefficient representing the priority.

9. A wireless base station device connected to a higher-level station device and comprising baseband processors, one for each virtual link to which one or more data flows belong wherein
each of said baseband processors comprises:
a congestion monitor that monitors a reception bandwidth usage rate of a virtual link, allocated to a cell, to detect congestion and, if congestion is detected, notifies congestion information to a flow controller;
a traffic distributor that distributes user traffic, received from said higher-level station device, to a traffic flow of each user and, at the same time, extracts a holding amount of a buffer in said higher-level station device for each data flow and notifies the extracted holding amount to the flow controller; and
the flow controller that manages a data flow of each user and, if the congestion information is notified by said congestion monitor, requests said higher-level station device to reduce rates of data flows in descending order of rates beginning with a data flow with a highest rate.

10. The wireless base station device as defined by claim 9 wherein said flow controller notifies information to said higher-level station device, said information requesting that the rate of a data flow be reduced to a rate determined by a ratio between the holding amount and a maximum holding time allowed in the buffer.

11. The wireless base station device as defined by claim 9 wherein said flow controller allocates priority to each of said data flows to set the maximum holding time corresponding to a high-priority data flow shorter.
